(19) United States
(12) Patent Application Publication
(10) Pub. No.: US 2012/0021265 A1
(43) Pub. Date: Jan. 26, 2012

(54) NONAQUEOUS SECONDARY BATTERY AND NONAQUEOUS SECONDARY BATTERY PACK

(75) Inventor: Kentaro Takahashi, Sumoto-shi (JP)

(73) Assignee: SANYO ELECTRIC CO., LTD., Osaka (JP)

(21) Appl. No.: 13/185,092

(22) Filed: Jul. 18, 2011

(30) Foreign Application Priority Data
Jul. 21, 2010 (JP) 2010-164135

(51) Int. Cl. H01M 10/0587; H01M 10/0585; H01M 2/30; H01M 2/02; H01M 2/24

(52) U.S. Cl. 429/94; 429/179; 429/158

(57) ABSTRACT

In a flat nonaqueous secondary battery, an electrode assembly formed by stacking or winding a positive electrode and a negative electrode with a separator interposed therebetween is sealed in a laminated outer body together with a nonaqueous electrolyte, and a positive electrode tab and a negative electrode tab are led out from the laminated outer body. The separator has a rupture elongation of 50% or more in at least the TD direction or the MD direction. A metal plate connected to the positive electrode tab is placed on an outer principal surface of the laminated outer body. This structure provides a nonaqueous secondary battery and a nonaqueous secondary battery pack that are extremely safe, being unlikely to emit smoke or explode even when a nail penetrates the battery in a charged state.

### TECHNICAL FIELD

The present invention relates to a nonaqueous secondary battery and a nonaqueous secondary battery pack each using a laminated outer body, and in particular, relates to a nonaqueous secondary battery and a nonaqueous secondary battery pack that are extremely safe, being unlikely to emit smoke or explode even when a nail penetrates the battery in a charged state.

### BACKGROUND ART

Nonaqueous secondary batteries represented by lithium ion secondary batteries having a high energy density and high capacity are widely used as power supplies for powering portable electronic equipment, such as cell phones, portable personal computers, and portable music players, as well as power supplies for hybrid electric vehicles (HEVs) and electric vehicles (EVs).

Such a nonaqueous secondary battery commonly includes a positive electrode including a positive electrode substrate made from, for example, a long sheet of aluminum foil having both sides coated with a positive electrode mixture containing a positive electrode active material that absorbs and desorbs lithium ions, and a negative electrode including a negative electrode substrate made from, for example, a long sheet of copper foil having both sides coated with a negative electrode mixture containing a negative electrode active material that absorbs and desorbs lithium ions. A prismatic nonaqueous secondary battery is produced as follows: a separator made from, for example, a microporous polyethylene film is placed between the positive electrode and the negative electrode; the positive electrode and the negative electrode insulated from each other by the separator are wound into a column shape or an elliptical shape to form a wound electrode assembly and then the wound electrode assembly is pressed to make a flat wound electrode assembly or the positive electrode and the negative electrode insulated from each other by the separator are stacked to form a laminated electrode assembly; a positive electrode tab and a negative electrode tab are connected to predetermined positions of the positive electrode and the negative electrode, respectively; the outside of the electrode is covered with a prismatic outer body; and a nonaqueous electrolyte is poured into the outer body.

Organic solvents such as ethylene carbonate (EC) and dimethyl carbonate (DMC) are widely used as a solvent of a nonaqueous electrolytic solution used in these nonaqueous secondary batteries. Thus, such a nonaqueous secondary battery adopts various safety measures in order not to cause accidents such as fire due to combustion even when the battery is used in harsh environments.

A metal outer can is mainly used for the outer body of the nonaqueous secondary battery in order to impart strength to the battery. However, a laminated battery using a metal-resin laminated film as the outer body in place of the outer can is known, and used in order, for example, to reduce the weight and to increase the battery capacity per unit volume.

For example, JP-A-2002-270239 discloses an invention of an electrochemical device that uses a flexible laminate film for an outer body. The electrochemical device includes a laminate of a positive electrode and a negative electrode with a separator interposed therebetween, and includes, at a position facing the outermost electrode of the laminate, a dummy electrode that is electrically connected to the electrode opposite to the outermost electrode and that does not include a film containing an electrode active material on a face facing the outermost electrode. According to the electrochemical device disclosed in JP-A-2002-270239, when the temperature of the electrochemical device is increased to a predetermined temperature or more, contraction of the separator in the dummy electrode starts to cause an internal short circuit between the dummy electrode and the outermost electrode, and the battery is discharged, especially in order to reduce the potential of the positive electrode. Thus, the thermal stability of the electrode is increased to be unlikely to cause thermal runaway, and therefore the explosion, burning, or similar dangerous condition of the electrochemical device can be suppressed.

JP-A-2008-140601 discloses an invention of a battery pack using a laminated film for an outer body. The battery pack is composed of at least one secondary battery including a power generation device that includes a positive electrode, a negative electrode, and an electrolyte and that is sealed with a laminated film composed of a metal foil and a resin and including an electrode tab that is connected to the positive electrode or the negative electrode. The battery pack further includes at least one metal plate that is fixed to the secondary battery and that is connected to the electrode tab. According to the invention of the battery pack disclosed in JP-A-2008-140601, because the metal plate is connected to the electrode tab of the battery pack, the metal plate can absorb exothermic heat of the secondary battery or the electrode tab part for heat dissipation, and therefore a comparatively small number of parts can relieve stress on the electrode tab and provide heat dissipation.

In a nonaqueous secondary battery using such a laminated outer body, the strength of the outer body is less than that of a battery using a metal outer can due to its structure, and thus the battery using the laminated outer body is required to meet higher safety with respect to internal short circuit caused by physical factors from the outside such as nail penetration. The electrochemical device and the battery pack, each using the laminated film as the outer body, disclosed in JP-A-2002-270239 and JP-A-2008-140601 have no consideration for the internal short circuit caused by, for example, the nail penetration.

The inventors of the present invention have repeatedly studied the mechanism of burning that may be caused when a conductor penetrates a nonaqueous secondary battery as represented by a nail penetration test in a nonaqueous secondary battery. As a result, the inventors have found that the penetration of, for example, a nail to a nonaqueous secondary battery causes a short circuit that generates exothermic heat; the exothermic heat forms an alteration product of an electrolyte between the nail and a positive electrode substrate to reduce the short circuit current flowing through a path of the negative electrode, the nail, and the positive electrode substrate; then the battery voltage is unlikely to be reduced; and as a result, the short circuit current flowing through a path of the negative electrode, the nail, and a positive electrode active material layer is increased to cause thermal runaway of the thermally unstable positive electrode active material layer.

It has also been found that the installation of a metal plate that is electrically connected to the positive electrode so as to be in contact with a cell flat surface part in parallel leads to the nail penetration through both the metal plate and the battery; the short circuit current also flows through a path of the negative electrode, the nail, the metal plate, the positive electrode substrate, and the positive electrode active material layer; the increase in the short circuit current flowing through the path of the negative electrode, the nail, and the positive electrode active material layer is suppressed to suppress the thermal runaway of the positive electrode active material; and as a result, the emission of smoke from and explosion of the battery are suppressed, and the separator having a rupture elongation within a predetermined range can more reliably suppress the emission of smoke from and explosion during the nail penetration test. Thus, the present invention has been completed.

### SUMMARY

An advantage of some aspects of the invention is to provide a nonaqueous secondary battery and a nonaqueous secondary battery pack that are extremely safe, being unlikely to emit smoke or explode even when a nail penetrates the battery in a charged state.

According to an aspect of the invention, a flat nonaqueous secondary battery includes a positive electrode including a positive electrode substrate having a surface with a positive electrode active material layer formed, a negative electrode including a negative electrode substrate having a surface with a negative electrode active material layer formed, a positive electrode tab connected to the positive electrode substrate, a negative electrode tab connected to the negative electrode substrate, and a separator. An electrode assembly formed by stacking or winding the positive electrode and the negative electrode with the separator interposed therebetween is sealed in a laminated outer body together with a nonaqueous electrolyte, and the positive electrode tab and the negative electrode tab are led out from the laminated outer body. In the nonaqueous secondary battery, the separator has a rupture elongation of 50% or more in at least the TD direction or the MD direction, and a metal plate connected to the positive electrode tab is placed on an outer principal surface of the laminated outer body.

The nonaqueous secondary battery according to the present aspect of the invention uses, in the above flat nonaqueous secondary battery, the separator having a rupture elongation of 50% or more in at least the TD direction or the MD direction, and the metal plate connected to the positive electrode tab is placed on an outer principal surface of the laminated outer body. The terms of TD direction and MD direction are common technical terms used in the technical field of film production. The MD direction means a longitudinal direction, that is, a machine direction of a separator during separator production, and the TD direction means a transverse direction, that is, a width direction of a separator during separator production.

In the nonaqueous secondary battery according to the present aspect of the invention, the metal plate placed on the surface of the laminated outer body is electrically connected to the positive electrode tab, and the nonaqueous secondary battery is penetrated together with the metal plate. When a nail penetrates the battery in a charged state, exothermic heat caused by a short circuit forms an alteration product of an electrolyte between the nail and the positive electrode substrate to reduce a short circuit current flowing through a path of the negative electrode, the nail, the positive electrode substrate, and the positive electrode active material layer. However, in the nonaqueous secondary battery according to the present aspect of the invention, the short circuit current also flows through a path of the negative electrode, the nail, the metal plate, the positive electrode substrate, and the positive electrode active material layer to suppress an increase in the short circuit current flowing through the path of the negative electrode, the nail, and the positive electrode active material layer. This structure suppresses thermal runaway of the thermally unstable positive electrode active material, thereby suppressing smoke emission and explosion.

In addition, in the nonaqueous secondary battery according to the present aspect of the invention, the separator used has a rupture elongation of 50% or more in at least the TD direction or the MD direction, whereby the separator is unlikely to be broken. Thus, the positive electrode active material layer is unlikely to be in contact with the negative electrode to further suppress the thermal runaway of the thermally unstable positive electrode active material layer, and the smoke or explosion can be further suppressed.

In the nonaqueous secondary battery according to the present aspect of the invention, it is preferable that the separator have a mass per unit area of 4.3 g/m² or more.

The thickness of the separator having a mass per unit area of 4.3 g/m² or more increases to increase a breaking strength of the separator, and thus the nonaqueous secondary battery according to the present aspect of the invention can further suppress the smoke or explosion. The mass per unit area of the separator is more preferably 4.7 g/m² or more and most preferably 5.0 g/m² or more. The upper limit of the mass per unit area of the separator is preferably 12.0 g/m² or less because an excessively large mass per unit area results in an excessively large thickness of the separator, increases the thickness of the nonaqueous secondary battery according to the present aspect of the invention, and increases the internal resistance.

In the nonaqueous secondary battery according to the present aspect of the invention, it is preferable that the nonaqueous electrolyte be a gel electrolyte.

The nonaqueous secondary battery according to the present aspect of the invention uses, as the outer body, an outer body having a smaller strength than that of a metal outer body. Thus, the use of a gel nonaqueous electrolyte achieves an additional effect of providing a more stable shape than when a liquid nonaqueous electrolyte is used.

In the nonaqueous secondary battery according to the present aspect of the invention, it is preferable that two metal plates be placed with the nonaqueous secondary battery interposed therebetween.

In the nail penetration of a nonaqueous secondary battery, not only does the nail completely penetrate the nonaqueous secondary battery but also the leading end of the nail may stop inside the battery. In such a case, when the nail penetrates from the side without the metal plate, the advantageous effects of the invention may not necessarily be achieved. With the nonaqueous secondary battery according to the present aspect of the invention, two metal plates are placed with the nonaqueous secondary battery interposed therebetween. The advantageous effects of the invention can be effectively achieved even when a nail penetrates from any direction.

According to another aspect of the invention, a nonaqueous secondary battery pack includes a plurality of flat nonaqueous secondary batteries stacked and integrated to form the battery pack. Each of the nonaqueous secondary batteries include a positive electrode including a positive electrode substrate having a surface with a positive electrode active material layer formed, a negative electrode including a negative electrode substrate having a surface with a negative electrode active material layer formed, a positive electrode tab connected to the positive electrode substrate, a negative electrode tab connected to the negative electrode substrate, and a separator. An electrode assembly formed by stacking or winding the positive electrode and the negative electrode with the separator interposed therebetween is sealed in a laminated outer body together with a nonaqueous electrolyte, and the positive electrode tab and the negative electrode tab are led out from the laminated outer body. In the nonaqueous secondary battery pack, the separator has a rupture elongation of 50% or more in at least the TD direction or the MD direction, a metal plate is placed on an outer principal surface of the laminated outer body of at least one flat nonaqueous secondary battery, and the metal plate is connected to the positive electrode tab of at least one flat nonaqueous secondary battery.

In the nonaqueous secondary battery pack according to the present aspect of the invention including a plurality of flat nonaqueous secondary batteries stacked and integrated, the separator has a rupture elongation of 50% or more in at least the TD direction or the MD direction, the metal plate is placed on the outer principal surface of the laminated outer body of at least one flat nonaqueous secondary battery, and the metal plate is connected to the positive electrode tab of at least one flat nonaqueous secondary battery. Thus, in the nonaqueous secondary battery pack according to the present aspect of the invention, when a nail penetrates the nonaqueous secondary battery pack including each flat nonaqueous secondary battery in a charged state and the nail penetrates at least the metal plate, the nonaqueous secondary battery pack can suppress the emission of smoke from and explosion by the same manner as that described in the nonaqueous secondary battery according to the present aspect of the invention.

Also in this case, it is preferable that the separator used in each flat nonaqueous secondary battery have a rupture elongation of 50% or more in at least the TD direction or the MD direction from the same reason as that described in the nonaqueous secondary battery according to the present aspect of the invention. In the nonaqueous secondary battery pack according to the present aspect of the invention, a plurality of flat nonaqueous secondary batteries may be connected in series to each other, may be connected in parallel to each other, may be connected in parallel and then connected in series to each other, or may be connected in series and then connected in parallel to each other.

In the nonaqueous secondary battery pack according to the present aspect of the invention, it is preferable that the separator have a mass per unit area of 4.3 g/m² or more.

Also in the nonaqueous secondary battery pack according to the present aspect of the invention, the thickness of the separator having a mass per unit area of 4.3 g/m² or more increases to increase the breaking strength of the separator, and thus the nonaqueous secondary battery pack according to the present aspect of the invention can further suppress the smoke or explosion. The mass per unit area of the separator is more preferably 4.7 g/m² or more and most preferably 5.0 g/m² or more. Also in this case, the upper limit of the mass per unit area of the separator is preferably 12.0 g/m² or less because an excessively large mass per unit area results in an excessively large thickness of the separator, increases the thickness of the nonaqueous secondary battery pack according to the present aspect of the invention, and increases the internal resistance.

In the nonaqueous secondary battery pack according to the present aspect of the invention, it is preferable that the nonaqueous electrolyte be a gel electrolyte.

Also in the nonaqueous secondary battery pack according to the present aspect of the invention, each flat nonaqueous secondary battery achieves an additional effect of providing a more stable shape than when a liquid nonaqueous electrolyte is used from the same reason as that described in the nonaqueous secondary battery according to the present aspect of the invention. The additional effect is remarkable because the nonaqueous secondary battery pack according to the present aspect of the invention is formed by stacking a plurality of flat nonaqueous secondary batteries.

In the nonaqueous secondary battery pack according to the present aspect of the invention, it is preferable that the metal plate be formed on the outermost surface of the nonaqueous secondary battery pack including the plurality of flat nonaqueous secondary batteries that are stacked and integrated.

In the nail penetration of a nonaqueous secondary battery pack, not only does the nail completely penetrate the nonaqueous secondary battery pack but also the leading end of the nail may stop inside one of the nonaqueous secondary batteries. In such a case, for example, when the metal plate is placed inside the nonaqueous secondary battery pack or a nail penetrates from the side opposite to the side having the metal plate and the nail does not penetrate the metal plate, the advantageous effects of the invention may not necessarily be achieved. With the nonaqueous secondary battery pack according to the present aspect of the invention, the metal plate is placed on the outermost surface of the nonaqueous secondary battery pack, and thus the advantageous effects of the nonaqueous secondary battery pack according to the present aspect of the invention can be effectively achieved when a nail penetrates at least from the side having the metal plate.

In the nonaqueous secondary battery pack according to the present aspect of the invention, it is preferable that the metal plate be formed on both outermost surfaces of the nonaqueous secondary battery pack including the plurality of flat nonaqueous secondary batteries stacked and integrated.

In the nail penetration of a nonaqueous secondary battery pack, not only does the nail completely penetrate the nonaqueous secondary battery pack but also the leading end of the nail may stop inside the nonaqueous secondary battery pack. In such a case, when the nail penetrates from the side without the metal plate, the advantageous effects of the invention may not necessarily be achieved. With the nonaqueous secondary battery pack according to the present aspect of the invention, two metal plates are placed with the nonaqueous secondary battery pack interposed therebetween. Even when a nail penetrates from any direction, the advantageous effects of the nonaqueous secondary battery pack according to the present aspect of the invention can be effectively achieved.

In the nonaqueous secondary battery pack according to the present aspect of the invention, it is preferable that the metal plate be formed on each of the flat nonaqueous secondary batteries and be independently connected to the positive electrode tab of each of the flat nonaqueous secondary batteries.

With the nonaqueous secondary battery pack according to the present aspect of the invention, the metal plate is formed on each of the flat nonaqueous secondary batteries and is independently connected to the positive electrode tab of each of the flat nonaqueous secondary batteries. With this structure, even when a nail penetrates from any thickness direction of the nonaqueous secondary battery pack, the advantageous effects of the nonaqueous secondary battery pack according to the present aspect of the invention can be effectively achieved.

### BRIEF DESCRIPTION OF THE DRAWINGS

The invention will be described with reference to the accompanying drawings, wherein like numbers reference like elements.

FIG. 1 is an exploded perspective view of a nonaqueous secondary battery using a laminated outer body used in each Example and Comparative Example.

FIG. 2 is an exploded perspective view of a plurality of nonaqueous secondary batteries, each using a laminated outer body, that are connected in series.

FIG. 3 is an exploded perspective view of a plurality of nonaqueous secondary batteries, each using a laminated outer body, that are connected in parallel.

### DESCRIPTION OF EXEMPLARY EMBODIMENTS

Hereinafter, exemplary embodiments of the invention will be described in detail with reference to various examples and comparative examples. However, the examples described below are merely illustrative examples of the nonaqueous secondary battery using a laminated outer body for embodying the technical spirit of the invention, and are not intended to limit the invention to the examples. The invention may be equally applied to various modified cases without departing from the technical spirit described in the claims.

### Experimental Example 1

Preparation of Positive Electrode

The positive electrode common to Examples and Comparative Examples was prepared as follows. First, 95% by mass of lithium cobalt oxide (LiCoO2) as a positive electrode active material, 2.5% by mass of activated carbon HS-100 (manufactured by Denki Kagaku Kogyo K. K.) as a conductive material, and 2.5% by mass of polyvinylidene fluoride (PVdF) powder as a binding agent were mixed. N-methyl-pyrrolidone (NMP) was added to the mixture so as to be 50% by mass of the positive electrode mixture mass to prepare an active material mixture slurry for the positive electrode. Next, the active material mixture slurry for the positive electrode was applied to both sides of a positive electrode substrate made of aluminum foil having a thickness of 13 μm by doctor blade method (coating amount: 400 g/m²). Then, the coated substrate was dried by heating (70 to 140° C.) to remove NMP, and formed by pressure (packing density of 3.70 g/cc) to prepare a positive electrode.

Preparation of Negative Electrode

The negative electrode common to Examples and Comparative Examples was prepared as follows. First, 97% by mass of artificial graphite (d=0.335 nm) as a negative electrode active material, 2% by mass of carboxymethyl cellulose (CMC) as a thickener, and 1% by mass of styrene-butadiene rubber (SBR) as a binding agent were mixed. Water was added to the mixture to prepare an active material mixture slurry for the negative electrode. Next, the active material mixture slurry for the negative electrode was applied to both sides of a negative electrode substrate made of copper foil having a thickness of 8 μm by doctor blade method (coating amount: 210 g/m²). Then, the coated substrate was dried to remove water, and formed by pressure (packing density of 1.60 g/cc) to prepare a negative electrode.

Separator

The separator used was a polyethylene microporous membrane having a thickness of 18 μm. The rupture elongation and mass per unit area of the separator were previously determined. The characteristics of each separator used in Examples and Comparative Examples are shown in Tables 1 to 3.

The rupture elongation was determined in accordance with JIS K-7127. That is, a polyethylene microporous membrane was cut out into a width of 10 mm and a length of 50 mm. The membrane had a clamping part having a length of 25 mm, and onto both sides of the clamping part, a cellophane tape was bonded in order to prevent a notch break due to the clamp to prepare a test piece. Then, the test piece was subjected to the test at a temperature of 23° C.±2° C. and a tensile strength of 200 mm/min. The mass per unit area was determined as follows: a separator having a width of 20 mm and a length of 50 mm was weighed, and the mass was converted into grams per 1 m².

Preparation of Battery Cell before Pouring

To each of the positive electrode and the negative electrode that was slitted at a predetermined length, a current collecting tab was welded. Then, the positive electrode and the negative electrode with the separator interposed therebetween were wound and pressed to prepare a flat wound electrode assembly. Next, the obtained flat wound electrode assembly was stored in a laminated outer body that was formed into a cup shape, and the outer body was sealed with heat except for a pour hole to prepare a battery before pouring.

Preparation of Nonaqueous Electrolytic Solution

To a nonaqueous solvent mixed with ethylene carbonate (EC), propylene carbonate (PC), and methyl pivalate in a volume ratio of 30:5:65 (at 1 atmosphere and 25° C.), LiPF₆ was dissolved at a ratio of 1.0 mol/L as an electrolyte salt to prepare a nonaqueous electrolytic solution used for each Example and Comparative Example.

Preparation of Pre-Gel Solution of Nonaqueous Electrolyte

In Examples 11 and 12 and Comparative Examples 19 to 22, a gel of the nonaqueous electrolytic solution was used as the electrolyte. That is, to the nonaqueous electrolytic solution obtained as above, polyethylene glycol #200 diacrylate A-200 (manufactured by Shin-Nakamura Chemical Co., Ltd.) was added as a monomer at 5.0% by mass with respect to the nonaqueous electrolytic solution. Then, tert-butyl peroxypivalate was added as a polymerization initiator at 0.3% by mass with respect to the nonaqueous electrolytic solution to prepare a nonaqueous electrolyte pre-gel solution used for Examples 11 and 12 and Comparative Examples 19 to 22.

Preparation of Battery Cell

In Examples 1 to 10 and Comparative Examples 1 to 18, 15 ml of the nonaqueous electrolytic solution prepared as above was poured from the pour hole into the battery cell before pouring, and then impregnation treatment was performed. Next, the pour hole was sealed with heat, and heat impregnation was performed at 60° C. for five hours. Then, the battery was charged and discharged to complete a nonaqueous secondary battery using a laminated outer body having a design capacity of 3900 mAh.

In Examples 11 and 12 and Comparative Examples 19 to 22, 15 ml of the nonaqueous electrolyte pre-gel solution prepared as above was poured from the pour hole into the battery cell before pouring, and then impregnation treatment was performed. Next, the pour hole was sealed with heat, and the pre-gel solution was thermally cured at 60° C. for five hours. Then, the battery was charged and discharged to complete a nonaqueous secondary battery using a laminated outer body having a design capacity of 3900 mAh.

Connection of Metal Plate

Among the nonaqueous secondary batteries, each using a laminated outer body, prepared as above, for each battery of Examples 1 to 12 and Comparative Examples 9 to 18 and 22, an aluminum plate having a thickness of 0.5 mm was placed so as to be in contact with a flat surface of the nonaqueous secondary battery using a laminated outer body while covering the flat surface in parallel, and the aluminum plate was connected to the positive electrode tab by ultrasonic welding (Examples 1 to 10 and Comparative Examples 9, 10, and 22), or the aluminum plate was connected to the negative electrode tab by ultrasonic welding (Comparative Examples 11 to 18) to prepare each battery pack used in Examples 1 to 10 and Comparative Examples 9 to 18. In Comparative Examples 1 to 8 and 19 to 21, the nonaqueous secondary battery using a laminated outer body without the metal plate was used as the battery pack.

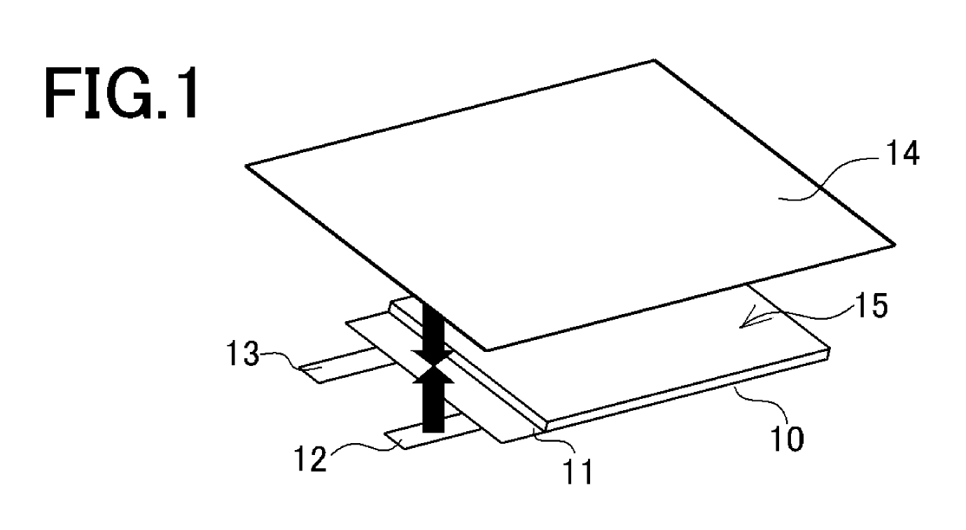

FIG. 1 shows the structure of the nonaqueous secondary battery using a laminated outer body that was prepared in this manner and that was common to Examples and Comparative Examples. FIG. 1 is an exploded perspective view of the nonaqueous secondary battery using a laminated outer body used in each Example and Comparative Example. That is, in a nonaqueous secondary battery 10 using a laminated outer body, a flat wound electrode assembly (not shown in FIG. 1) is placed in a laminated outer body 11 that is formed into a cup shape, a positive electrode current collecting tab 12 and a negative electrode current collecting tab 13 are attached so as to be exposed outside from one end of the laminated outer body 11. When a metal plate 14 is used, the metal plate 14 is bonded onto one outer principal surface 15 of the nonaqueous secondary battery 10 using a laminated outer body with an adhesive or a double-sided adhesive tape, and the metal plate 14 is electrically connected to the positive electrode tab 12 or the negative electrode tab 13 by ultrasonic welding.

Measurement of Nail Penetration Characteristics

Nail penetration characteristics of 15 battery packs of each of Examples 1 to 12 and Comparative Examples 19 to 22 prepared as above were determined at an atmosphere temperature of 23° C. as follows. First, the battery was charged at a constant current of 1 It=3900 mA until the battery voltage reached 4.3 V, and then charged at a constant voltage of 4.3 V until the current reached 50 mA. Then, an iron nail having a diameter of 2.5 penetrated through an approximately center of the electrode assembly at a speed of 10 mm/s, and the battery was left for 30 minutes. The number of batteries that emitted smoke or exploded was counted to be regarded as the nail penetration characteristics. Table 1 shows the results from Examples 1 to 10 and Comparative Examples 1 to 18 that used the liquid electrolyte as the electrolyte, and Table 2 shows the results from Examples 11 and 12 and Comparative Examples 19 to 22 that used the gel electrolyte as the electrolyte.

TABLE 1

| | | | | | | | Number |
|---|---|---|---|---|---|---|---|
| | | | | | | | of |
| | | | | Rupture | | Mass | batteries |
| | | With or | Electrode | elonga- | | per | that |
| | | without | connected | tion | | unit | emitted |
| | Electro- | metal | to metal | (%) | | area | smoke or |
| | lyte | plate | plate | TD | MD | (g/m²) | exploded |
| Comparative | Liquid | Without | — | 40 | 60 | 7.3 | 15 |
| Example 1 | | | | | | | |
| Comparative | Liquid | Without | — | 45 | 30 | 7.5 | 15 |
| Example 2 | | | | | | | |
| Comparative | Liquid | Without | — | 46 | 30 | 7.2 | 15 |
| Example 3 | | | | | | | |
| Comparative | Liquid | Without | — | 50 | 35 | 7.3 | 15 |
| Example 4 | | | | | | | |
| Comparative | Liquid | Without | — | 55 | 30 | 7.2 | 15 |
| Example 5 | | | | | | | |
| Comparative | Liquid | Without | — | 63 | 20 | 7.1 | 15 |
| Example 6 | | | | | | | |
| Comparative | Liquid | Without | — | 110 | 30 | 7.3 | 15 |
| Example 7 | | | | | | | |
| Comparative | Liquid | Without | — | 230 | 30 | 7.3 | 15 |
| Example 8 | | | | | | | |
| Example 1 | Liquid | With | Positive | 40 | 60 | 7.3 | 3 |
| | | | electrode | | | | |
| Comparative | Liquid | With | Positive | 45 | 30 | 7.5 | 15 |
| Example 9 | | | electrode | | | | |
| Comparative | Liquid | With | Positive | 46 | 30 | 7.2 | 15 |
| Example 10 | | | electrode | | | | |
| Example 2 | Liquid | With | Positive | 50 | 35 | 7.3 | 3 |
| | | | electrode | | | | |
| Example 3 | Liquid | With | Positive | 55 | 30 | 7.2 | 2 |
| | | | electrode | | | | |
| Example 4 | Liquid | With | Positive | 63 | 20 | 7.1 | 3 |
| | | | electrode | | | | |
| Example 5 | Liquid | With | Positive | 110 | 30 | 7.3 | 3 |
| | | | electrode | | | | |
| Example 6 | Liquid | With | Positive | 230 | 30 | 7.3 | 2 |
| | | | electrode | | | | |
| Comparative | Liquid | With | Negative | 40 | 60 | 7.3 | 15 |
| Example 11 | | | electrode | | | | |
| Comparative | Liquid | With | Negative | 45 | 30 | 7.5 | 15 |
| Example 12 | | | electrode | | | | |
| Comparative | Liquid | With | Negative | 46 | 30 | 7.2 | 15 |
| Example 13 | | | electrode | | | | |
| Comparative | Liquid | With | Negative | 50 | 35 | 7.3 | 15 |
| Example 14 | | | electrode | | | | |
| Comparative | Liquid | With | Negative | 55 | 30 | 7.2 | 15 |
| Example 15 | | | electrode | | | | |
| Comparative | Liquid | With | Negative | 63 | 20 | 7.1 | 15 |
| Example 16 | | | electrode | | | | |
| Comparative | Liquid | With | Negative | 110 | 30 | 7.3 | 15 |
| Example 17 | | | electrode | | | | |
| Comparative | Liquid | With | Negative | 230 | 30 | 7.3 | 15 |
| Example 18 | | | electrode | | | | |
| Example 7 | Liquid | With | Positive | 55 | 30 | 6.6 | 3 |
| | | | electrode | | | | |
| Example 8 | Liquid | With | Positive | 55 | 30 | 5.0 | 3 |
| | | | electrode | | | | |
| Example 9 | Liquid | With | Positive | 55 | 30 | 4.7 | 6 |
| | | | electrode | | | | |
| Example 10 | Liquid | With | Positive | 55 | 30 | 4.3 | 10 |
| | | | electrode | | | | |

The following can be determined from the results shown in Table 1. First, each battery without the metal plate of Comparative Examples 1 to 8 and 19 to 21 caused smoke or explosion regardless of the rupture elongation of the separator. In Comparative Examples 11 to 18, each battery had the metal plate but the metal plate was connected to the negative electrode, and all batteries emitted smoke or exploded.

In contrast, in Examples 1 to 6, the number of batteries that emitted smoke or exploded was suppressed to two or three, and thus safety in the nail penetration test was significantly improved.

That is, from the contrast of the test result of Example 1 to the test results of Comparative Examples 1 and 11, from the contrast of the test result of Example 2 to the test results of Comparative Examples 4 and 14, from the contrast of the test result of Example 3 to the test results of Comparative Examples 5 and 15, from the contrast of the test result of Example 4 to the test results of Comparative Examples 6 and 16, from the contrast of the test result of Example 5 to the test results of Comparative Examples 7 and 17, and from the contrast of the test result of Example 6 to the test results of Comparative Examples 8 and 18, it is clear that installation of the metal plate connected to the positive electrode greatly improves the nail penetration characteristics.

Such effects are considered to be derived from the following mechanisms. First, in the case of each conventional nonaqueous secondary battery using a laminated outer body without the metal plate that is connected to the positive electrode tab (corresponding to Comparative Examples 1 to 8), the penetration of a nail into the battery forms an alteration product of the electrolyte between the nail and the positive electrode substrate due to the exothermic heat by short-circuit and reduces the short circuit current flowing through a path of the negative electrode, the nail, the positive electrode substrate, and the positive electrode active material layer. As a result, the battery voltage is not easily reduced so as to increase the short circuit current flowing through a path of the negative electrode, the nail, and the positive electrode active material layer. Then, in the positive electrode active material layer, the thermally unstable positive electrode active material composed of LiCoO₂ is decomposed to generate oxygen, and the oxygen is reacted with an organic solvent in the nonaqueous electrolyte to generate heat. Thus, the battery temperature is increased to further accelerate decomposition reaction of the positive electrode active material composed of LiCoO₂ (thermal runaway), and the battery ultimately explodes.

In contrast, when the metal plate that is electrically connected to the positive electrode is bonded onto at least one outer principal surface of the nonaqueous secondary battery using a laminated outer body, a nail penetrates the nonaqueous secondary battery using a laminated outer body together with the metal plate in the nail penetration test. Thus, even when alteration products of the electrolyte is formed between the nail and the positive electrode substrate by the penetration of the nail, the short circuit current flows through a path of the negative electrode, the nail, and the metal plate (positive electrode) to suppress the increase in the short circuit current flowing through a path of the negative electrode, the nail, and the positive electrode active material layer. Hence, the decomposition of the positive electrode active material is suppressed, and consequently the emission of smoke and explosion are suppressed.

In the battery having the metal plate connected to the negative electrode substrate, as with conventional batteries, the alteration product of the electrolyte is formed between the nail and the positive electrode substrate to reduce the short circuit current flowing through the path of the negative electrode, the nail, the positive electrode substrate, and the positive electrode active material layer. As a result, the battery voltage is not easily reduced so as to increase the short circuit current flowing through the path of the negative electrode, the nail, and the positive electrode active material layer. Hence, the decomposition reaction of the positive electrode active material composed of LiCoO₂ cannot be suppressed. This speculation supports the result of each battery having the metal plate connected to the negative electrode substrate in Comparative Examples 11 to 18, that is, the smoke or explosion was not suppressed.

In the results of Comparative Examples 9 and 10, it is recognized that even when the metal plate was connected to the positive electrode tab, the smoke or explosion was not suppressed. This is considered to be because the separator had an insufficient rupture elongation. That is, the penetration of a nail forms a through hole in the separator, and the separator is readily ruptured from the through hole due to a small rupture elongation. As a result, the positive electrode active material layer is supposed to be in contact with the negative electrode active material layer.

In order to sufficiently suppress the smoke or explosion in the nail penetration test, the results of Examples 2 to 6 confirm that a rupture elongation of the separator of 50% or more in the TD direction can significantly reduce the number of batteries that emit smoke or explode, and that a rupture elongation in the TD direction of less than 50% but a large rupture elongation in the MD direction can also significantly reduce the number of batteries that emit smoke or explode. Interpolation of the results of Example 1 and Comparative Examples 9 and 10 suggests that a rupture elongation in the MD direction of 50% or more achieves the fore-going effect.

Separator characteristics for improving the safety during the nail penetration test include a mass per unit area in addition to the rupture elongation. That is, the results of Examples 3 and 7 to 10 confirm that a smaller mass per unit area reduces the suppressive effect on the smoke emission from or explosion of the battery. It is revealed that the mass per unit area of the separator is preferably 4.3 g/m² or more, more preferably 4.7 g/m² or more, and even more preferably 5.0 g/m² or more. The upper limit of the mass per unit area of the separator is preferably 12.0 g/m² or less because an excessively large mass per unit area results in an excessively large thickness of the separator, increases the thickness of the nonaqueous secondary battery according to the present embodiment of the invention, and increases the internal resistance.

TABLE 2

| | | | | | | | Number |
|---|---|---|---|---|---|---|---|
| | | | | | | | of |
| | | | | Rupture | | Mass | batteries |
| | | With or | Electrode | elonga- | | per | that |
| | | without | connected | tion | | unit | emitted |
| | Electro- | metal | to metal | (%) | | area | smoke or |
| | lyte | plate | plate | TD | MD | (g/m²) | exploded |
| Comparative | Gel | Without | — | 46 | 30 | 7.2 | 15 |
| Example 19 | | | | | | | |
| Comparative | Gel | Without | — | 50 | 35 | 7.3 | 15 |
| Example 20 | | | | | | | |
| Comparative | Gel | Without | — | 55 | 30 | 7.2 | 15 |
| Example 21 | | | | | | | |
| Comparative | Gel | With | Positive | 46 | 30 | 7.2 | 15 |
| Example 22 | | | electrode | | | | |
| Example 11 | Gel | With | Positive | 50 | 35 | 7.3 | 0 |
| | | | electrode | | | | |
| Example 12 | Gel | With | Positive | 55 | 30 | 7.2 | 0 |
| | | | electrode | | | | |

The results of Examples 11 and 12 and Comparative Examples 19 to 22 shown in Table 2 reveal that each battery using the gel electrolyte as the electrolyte also achieved the advantageous effects of the invention as with the battery using the liquid electrolyte. In particular, in Example 11 and 12, no battery emitted smoke or exploded. From the comparison of Example 11 with Example 2, and from the comparison of Example 12 with Example 3, it is considered that the use of the gel electrolyte as the electrolyte more remarkably achieves the advantageous effects of the invention.

Experimental Example 1 exemplified the battery having one metal plate, but two metal plates can also be used. In the nail penetration of a nonaqueous secondary battery, not only does the nail completely penetrate the nonaqueous secondary battery but also the leading end of the nail may stop inside the battery. In such a case, when the nail penetrates from the side without the metal plate, the advantageous effects of the invention may not necessarily be achieved. Thus, for example, the installation of two metal plates with the nonaqueous secondary battery interposed therebetween can more reliably achieve the advantageous effects of the invention with respect to the nail penetration from any direction. The embodiment exemplified that the metal plate was connected to the electrode tab by ultrasonic welding. However, the connection may be performed by other methods such as screw clamp, welding, soldering, and crimping connection as long as the metal plate can be electrically connected to the electrode tab.

### Experimental Example 2

Next, two cells prepared in the same manner as that in Experimental Example 1 were connected in series or in parallel and stacked to form a battery pack. Then, an aluminum plate having a thickness of 0.5 mm was placed so as to be in contact with a flat surface of the nonaqueous secondary battery using a laminated outer body while covering the flat surface in parallel. The aluminum plate was connected to one of the positive electrode tabs of the battery pack by ultrasonic welding to prepare a battery pack of each of Examples 13 to 16 and Comparative Examples 23 to 26. The nail penetration characteristics of the battery pack were determined in a similar manner to that in Experimental Example 1, and the results are shown in Table 3.

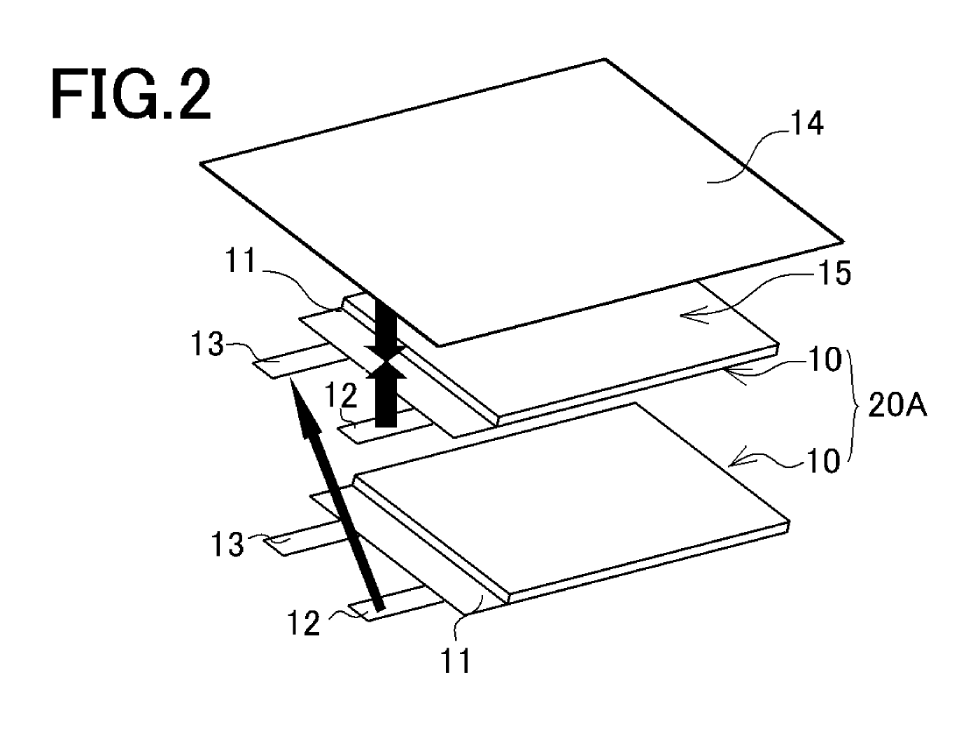

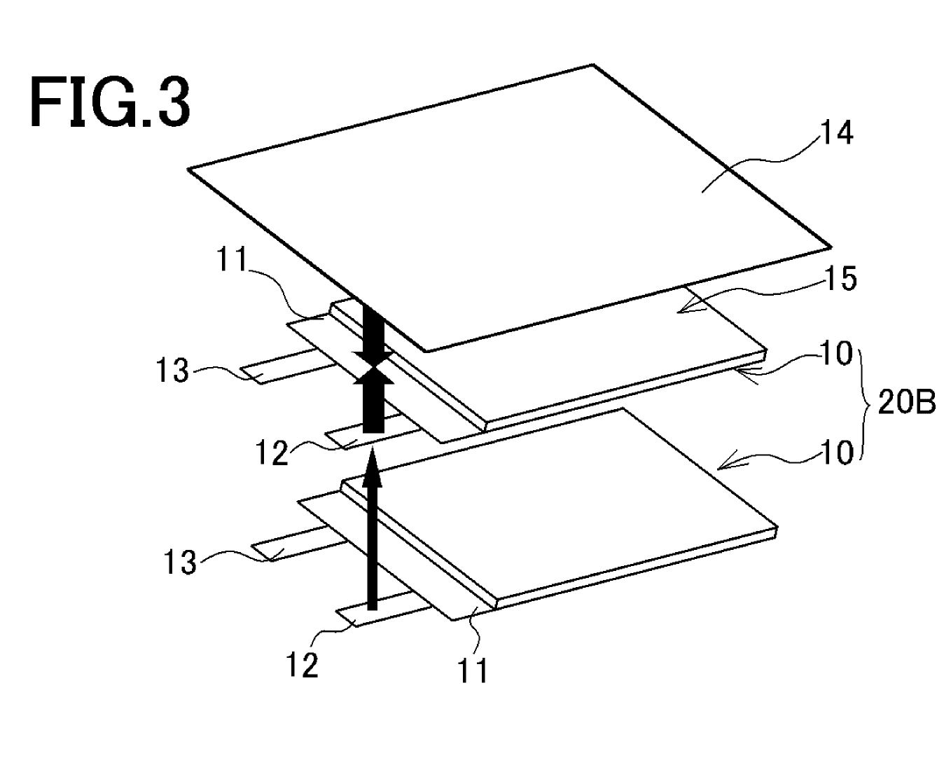

In Experimental Example 2, FIG. 2 shows an exploded perspective view of a nonaqueous secondary battery pack 20A that is formed by connecting two nonaqueous secondary batteries, each using a laminated outer body, in series, and FIG. 3 shows an exploded perspective view of a nonaqueous secondary battery pack 20B that is formed by connecting two nonaqueous secondary batteries, each using a laminated outer body, in parallel. In FIG. 2 and FIG. 3, the same component as that of the nonaqueous secondary battery 10 using a laminated outer body shown in FIG. 1 is expressed by the same reference numeral, and the detailed description will be omitted.

Two cells to be connected in series or in parallel used the same electrolyte and the separator having the same rupture elongation and mass per unit area. That is, two nonaqueous secondary batteries, each using a laminated outer body, that were the same as those of Example 2 and Comparative Examples 4 and 14 were connected in series for Example 13, and connected in parallel for Example 15. Two nonaqueous secondary batteries, each using a laminated outer body, that were the same as those of Example 3 and Comparative Examples 5 and 15 were connected in series for Example 14, and connected in parallel for Example 16. Two nonaqueous secondary batteries, each using a laminated outer body, that were the same as those of Comparative Examples 2, 9, and 12 were connected in series for Comparative Example 23, and connected in parallel for Comparative Example 25. Two nonaqueous secondary batteries, each using a laminated outer body, that were the same as those of Comparative Examples 3, 10, and 12 were connected in series for Comparative Example 24, and connected in parallel for Comparative Example 26.

TABLE 3

| | | | | | | | Number |
|---|---|---|---|---|---|---|---|
| | | | | | | | of |
| | Cell | | | Rupture | | Mass | batteries |
| | structure | | Electrode | elonga- | | per | that |
| | connec- | | connected | tion | | unit | emitted |
| | tion | Electro- | to metal | (%) | | area | smoke or |
| | method | lyte | plate | TD | MD | (g/m²) | exploded |
| Comparative | Series | Liquid | Positive | 45 | 30 | 7.5 | 15 |
| Example 23 | | | electrode | | | | |
| Comparative | Series | Liquid | Positive | 46 | 30 | 7.5 | 15 |
| Example 24 | | | electrode | | | | |
| Example 13 | Series | Liquid | Positive | 50 | 35 | 7.3 | 2 |
| | | | electrode | | | | |
| Example 14 | Series | Liquid | Positive | 55 | 30 | 7.2 | 3 |
| | | | electrode | | | | |
| Comparative | Parallel | Liquid | Positive | 45 | 30 | 7.5 | 15 |
| Example 25 | | | electrode | | | | |
| Comparative | Parallel | Liquid | Positive | 46 | 30 | 7.2 | 15 |
| Example 26 | | | electrode | | | | |
| Example 15 | Parallel | Liquid | Positive | 50 | 35 | 7.3 | 4 |
| | | | electrode | | | | |
| Example 16 | Parallel | Liquid | Positive | 55 | 30 | 7.2 | 4 |
| | | | electrode | | | | |

The results shown in Table 3 reveal that the number of battery packs that emitted smoke or exploded was largely reduced in Examples 13 to 16 than in Comparative Examples 23 to 26, and that the advantageous effects of the invention by the installation of the metal plate electrically connected to the positive electrode so as to be in contact with the flat surface of the cell in parallel and by a rupture elongation of the separator in the TD direction or in the MD direction of 50% or more could be achieved even in the battery pack that was prepared by connecting a plurality of cells, and that the cells can be connected in series or in parallel.

In this case, the mass per unit area of the separator may be determined in a similar manner to that in Experimental Example 1. That is, the thickness of the separator having a mass per unit area of 4.3 g/m² or more increases to increase the breaking strength of the separator also in the case of the nonaqueous secondary battery pack, and thus the nonaqueous secondary battery pack according to the present embodiment of the invention can further suppress the emission of smoke and explosion. The mass per unit area of the separator is more preferably 4.7 g/m² or more and most preferably 5.0 g/m² or more. Also in this case, the upper limit of the mass per unit area of the separator is preferably 12.0 g/m² or less because an excessively large mass per unit area results in an excessively large thickness of the separator, increases the thickness of the nonaqueous secondary battery pack according to the present embodiment of the invention, and increases the internal resistance.

Experimental Example 2 exemplified the nonaqueous secondary battery pack that was prepared by stacking two flat nonaqueous secondary batteries each having a laminated outer body. However the number of flat nonaqueous secondary batteries to be stacked is optional as long as the number is two or more. Connection manners of the flat nonaqueous secondary batteries do not only consist of serial connection and parallel connection, but also a plurality of flat nonaqueous secondary batteries may be connected in parallel and then connected in series to each other, or may be connected in series and then connected in parallel to each other.

Experimental Example 2 exemplified the nonaqueous secondary battery pack including two flat nonaqueous secondary batteries stacked and integrated and having one metal plate on the outermost surface. However, the metal plate may be placed inside the nonaqueous secondary battery pack composed of a plurality of stacked flat nonaqueous secondary batteries, or the metal plate may be placed on both outermost surfaces of the nonaqueous secondary battery pack.

However, in the nail penetration of a nonaqueous secondary battery pack, not only does the nail completely penetrate the nonaqueous secondary battery pack but also the leading end of the nail may stop inside one of the nonaqueous secondary batteries. In such a case, for example, when the metal plate is placed inside the nonaqueous secondary battery pack or a nail penetrates from the side opposite to the side having the metal plate and the nail does not penetrate the metal plate, desired effects may not necessarily be achieved. Considering such conditions, the nonaqueous secondary battery pack composed of a plurality of stacked flat nonaqueous secondary batteries having the metal plate inside the battery pack and the nonaqueous secondary battery pack having the metal plate on both outermost surfaces have increased possibility for a nail to penetrate the metal plate, and thus the desired effects are readily achieved.

The battery pack composed of the flat nonaqueous secondary batteries each having the metal plate that is independently connected to the positive electrode tab of each flat nonaqueous secondary battery obtains the largest possibility for a nail to penetrate the metal plate even when the nail penetrates from any thickness direction of the nonaqueous secondary battery pack, and thus the desired effects of the nonaqueous secondary battery pack can be effectively achieved.

Examples of the separator usable in the invention include microporous membranes made of polyolefin materials such as polypropylene and polyethylene. The materials may be mixed with a resin having a low melting point to ensure shutdown response, or with a resin having a high melting point to improve heat resistance, or may be laminated with a resin having a high melting point.

Examples of the metal plate usable in the invention include metal plates made of copper, aluminum, or an alloy of these that has excellent electrical conductivity and heat dissipation properties. Thickness may be properly determined depending on the thickness of the nonaqueous secondary battery using a laminated outer body to which the metal plate is bonded. The thickness is desirably in a range of 0.5 to 1.5 mm in order not to interfere with lightweight properties that are the advantage of the battery having a laminated outer body. The metal plate may be bonded to the laminated outer body surface using various adhesives, double-sided adhesive tape, and similar methods.

Experimental Example 1 and Experimental Example 2 exemplified the battery using LiCoO₂ as the positive electrode active material. Examples of other positive electrode active materials usable in the invention include generally used conventional lithium transition-metal composite oxides capable of absorbing and desorbing lithium ions reversibly, such as LiNiO_{2,} LiNiₓCo₁₋ₓO₂ (x=0.01 to 0.99), LiMnO_{2,} LiMn₂O_{4,} LiCoₓMn_{y}Ni_{z}O₂ (x+y+z=1), and phosphoric acid compound having an olivine structure, such as LiFePO_{4.}

Examples of negative electrode active material usable in the invention include, besides common graphite, carbon materials such as non-graphitizable carbon and graphitizable carbon, titanium oxides such as LiTiO₂ and TiO_{2,} metalloid elements such as silicon and tin, and Sn—Co alloy.

Experimental Example 1 and Experimental Example 2 exemplified the battery using EC, PC, and methyl pivalate as the solvent in the nonaqueous electrolytic solution. Examples of nonaqueous solvent (organic solvent) that constitutes the nonaqueous electrolytic solution and that is usable in the invention include cyclic carbonates such as EC, PC, and butylene carbonate (BC), cyclic carboxylic acid esters such as γ-butyrolactone (γ-BL) and γ-valerolactone (γ-VL), chain carbonates such as dimethyl carbonate (DMC), ethyl methyl carbonate (EMC), diethyl carbonate (DEC), and di-n-butyl carbonate (DNBC), chain carboxylic acid ester such a methyl pivalate, ethyl pivalate, methyl isobutyrate, and methyl propionate, amide compounds such as N,N′-dimethylformamide and N-methyloxazolidinone, sulfur compounds such as sulfolane, and ambient temperature molten salts such as 1-ethyl-3-methylimidazolium tetrafluoroborate. Among them, EC, PC, chain carbonates, and tertiary carboxylic acid esters are preferred. These nonaqueous solvents may be used singly or as a mixture of two or more of them, and are preferably used as a mixture of two or more of them.

The nonaqueous electrolyte used in the invention may further include, as a compound for stabilizing electrodes, vinylene carbonate (VC), vinyl ethyl carbonate (VEC), succinic acid anhydride (SUCAH), maleic acid anhydride (MAAH), glycolic acid anhydride, ethylene sulfite (ES), divinyl sulfone (VS), vinyl acetate (VA), vinyl pivalate (VP), catechol carbonate, cyclohexylbenzene (CHB), biphenyl (BP), and the like. These compounds may be used singly or as a mixture of two or more of them.

Experimental Example 1 and Experimental Example 2 exemplified the battery using LiPF₆ as the solute of the nonaqueous electrolyte. Examples of usable solute of nonaqueous electrolyte in the invention include various lithium salts that are commonly used as an electrolyte salt in nonaqueous secondary batteries. Examples of such lithium salts include, besides LiPF_{6,} LiBF_{4,} LiCF₃SO_{3,} LiN(CF₃SO₂)_{2,} LiN(C₂F₅SO₂)_{2,} LiAsF_{6,} LiClO_{4,} LiN(CF₃SO₂)(C₄F₉SO₂), LiC(CF₃SO₂)_{3,} LiC(C₂F₅SO₂)_{3,} Li₂B₁₀Cl_{10,} and Li₂B₁₂Cl_{12.} Among them, LiPF₆ is especially preferred. These lithium salts may be used singly or as a mixture of two or more of them.

Examples of a usable monomer having a (meth)acrylic end group as the gelling agent in the invention include monomers having an unsaturated double bond, such as methyl acrylate, ethyl acrylate, 2-ethoxyethyl acrylate, 2-methoxyethyl acrylate, polyethylene glycol monoacrylate, 2-ethoxyethyl acrylate, 2-ethoxyethyl methacrylate, polyethylene glycol monomethacrylate, N,N-diethylaminoethyl acrylate, glycidyl acrylate, allyl acrylate, acrylonitrile, diethylene glycol diacrylate, tetraethylene glycol diacrylate, polyethylene glycol diacrylate, polyethylene glycol dimethacrylate, polypropylene glycol diacrylate, polypropylene glycol dimethacrylate, polyalkylene glycol dimethacrylate, polyalkylene glycol diacrylate, trimethylolpropane alkoxylate triacrylate, pentaerythritol alkoxylate triacrylate, and pentaerythritol alkoxylate tetraacrylate.

Such a monomer having an unsaturated double bond can be polymerized by heat, ultraviolet rays, electron beams, and similar methods. In order to effectively develop the reaction, the nonaqueous electrolytic solution preferably includes a polymerization initiator as used in Experimental Example 1 and Experimental Example 2. Examples of the polymerization initiator include organic peroxides such as benzoyl peroxide, t-butylperoxycumene, lauroyl peroxide, di-2-ethylhexyl peroxydicarbonate, t-butyl peroxypivalate, and t-hexylperoxy isopropyl monocarbonate.

What is claimed is:

1. A flat nonaqueous secondary battery comprising:
a positive electrode including a positive electrode substrate having a surface with a positive electrode active material layer formed;
a negative electrode including a negative electrode substrate having a surface with a negative electrode active material layer formed;
a positive electrode tab connected to the positive electrode substrate;
a negative electrode tab connected to the negative electrode substrate; and
a separator;
an electrode assembly formed by stacking or winding the positive electrode and the negative electrode with the separator interposed therebetween being sealed in a laminated outer body together with a nonaqueous electrolyte,
the positive electrode tab and the negative electrode tab being led out from the laminated outer body,
the separator having a rupture elongation of 50% or more in at least a TD direction or an MD direction, and
a metal plate connected to the positive electrode tab being placed on an outer principal surface of the laminated outer body.

2. The nonaqueous secondary battery according to claim 1, wherein the separator has a mass per unit area of 4.3 g/m² or more.

3. The nonaqueous secondary battery according to claim 1, wherein the nonaqueous electrolyte is a gel electrolyte.

4. The nonaqueous secondary battery according to claim 1, wherein two metal plates are placed with the nonaqueous secondary battery interposed therebetween.

5. A nonaqueous secondary battery pack comprising:
a plurality of flat nonaqueous secondary batteries stacked and integrated to form the battery pack, each of the flat nonaqueous secondary batteries comprising:
a positive electrode including a positive electrode substrate having a surface with a positive electrode active material layer formed;
a negative electrode including a negative electrode substrate having a surface with a negative electrode active material layer formed;
a positive electrode tab connected to the positive electrode substrate;
a negative electrode tab connected to the negative electrode substrate; and
a separator;
an electrode assembly formed by stacking or winding the positive electrode and the negative electrode with the separator interposed therebetween being sealed in a laminated outer body together with a nonaqueous electrolyte,
the positive electrode tab and the negative electrode tab being led out from the laminated outer body,
the separator having a rupture elongation of 50% or more in at least a TD direction or an MD direction, and
a metal plate being placed on an outer principal surface of the laminated outer body of at least one flat nonaqueous secondary battery, and the metal plate is connected to the positive electrode tab of at least one flat nonaqueous secondary battery.

6. The nonaqueous secondary battery pack according to claim 5, wherein the separator has a mass per unit area of 4.3 g/m² or more.

7. The nonaqueous secondary battery pack according to claim 5, wherein the nonaqueous electrolyte is a gel electrolyte.

8. The nonaqueous secondary battery pack according to claim 5, wherein the metal plate is formed on an outermost surface of the nonaqueous secondary battery pack including the plurality of flat nonaqueous secondary batteries stacked and integrated.

9. The nonaqueous secondary battery pack according to claim 5, wherein the metal plate is formed on both outermost surfaces of the nonaqueous secondary battery pack including the plurality of flat nonaqueous secondary batteries stacked and integrated.

10. The nonaqueous secondary battery pack according to claim 5, wherein the metal plate is formed on each of the flat nonaqueous secondary batteries and is independently connected to the positive electrode tab of each of the flat nonaqueous secondary batteries.
